(19) United States
(12) Patent Application Publication
(10) Pub. No.: US 2020/0339486 A1
(43) Pub. Date: Oct. 29, 2020

(54) Methods and Systems for Enhanced Plant Growth and Antioxidation

(71) Applicant: Advanced Environmental Technologies LLC, Fort Collins, CO (US)

(72) Inventors: Song Jin, Fort Collins, CO (US); Paul Fallgren, Fort Collins, CO (US)

(21) Appl. No.: 16/398,085

(22) Filed: Apr. 29, 2019

(51) Int. Cl. C05G 3/04; C05F 11/02; C05F 5/00; C05F 7/00; C05F 3/04; A01C 21/00

(52) U.S. Cl. CPC C05G 3/04; C05F 11/02; A01C 21/00; C05F 7/005; C05F 3/04; C05F 5/002

(57) ABSTRACT

Embodiments of the present invention may provide a soil amendment which can increase the soil permeability, increase a plant's ability to repel pests and even its antioxidant capabilities such as to provide anti-browning of its fruit, larger crop yields, larger fruit and vegetables, or the like.

### BACKGROUND OF THE INVENTION

In the past, chemical fertilizers may be harmful to the environment, may cause cancer, may contain antibiotics, and may even have pesticides. Fertilizers may pollute the water, may have the potential to create toxic waste, may decrease soil health, or the like. It may be desirable develop a new organic soil amendment which may be used to enhance plant growth.

### SUMMARY OF THE INVENTION

It is an object in embodiments of the present invention to provide an organic soil amendment that can enhance plant growth and even its antioxidant capabilities.

An object of the present invention, in embodiments, may provide utilizing organic carbon in soil to increase plant health.

Another object of the present invention, in embodiments, may provide an anti-browning fruit.

Naturally, further objects, goals and embodiments of the inventions are disclosed throughout other areas of the specification, claims, and drawings.

### BRIEF DESCRIPTION OF THE DRAWINGS

FIG. 1 shows a representative drawing of a plant enhancement system in accordance with some embodiments of the present invention.

FIG. 2 shows a representative drawing of a soil amendment in accordance with some embodiments of the present invention.

FIG. 3 shows a photograph of a non-limiting example of a potato grown with a soil amendment in accordance with some embodiments of the present invention.

FIG. 4 shows a photograph of a non-limiting example of a potato grown without a soil amendment in accordance with some embodiments of the present invention.

FIG. 5 shows a photograph of a non-limiting example of a corn plot infected with pests in accordance with some embodiments of the present invention.

FIG. 6 shows a photograph of a non-limiting example of a corn plot with a soil amendment in accordance with some embodiments of the present invention.

FIG. 7 shows a photograph of a non-limiting example of a comparison of fruit produced by a plant without a soil amendment and fruit produced by a plant with a soil amendment immediately after each had been sliced in accordance with some embodiments of the present invention.

FIG. 8 shows a photograph of a non-limiting example of a comparison of fruit produced by a plant without a soil amendment and fruit produced by a plant with a soil amendment about 23 minutes after each had been sliced in accordance with some embodiments of the present invention.

FIG. 9 shows a photograph of a non-limiting example of a comparison of fruit produced by a plant without a soil amendment and fruit produced by a plant with a soil amendment about an hour and thirty-three minutes after each had been sliced in accordance with some embodiments of the present invention.

FIG. 10 shows a photograph of a non-limiting example of a comparison of fruit produced by a plant without a soil amendment and fruit produced by a plant with a soil amendment about five hours and twenty minutes after each had been sliced in accordance with some embodiments of the present invention.

FIG. 11 shows a photograph of a non-limiting example of a comparison of fruit produced by a plant without a soil amendment and fruit produced by a plant with a soil amendment about six hours after each had been sliced in accordance with some embodiments of the present invention.

FIG. 12 shows a photograph of a non-limiting example of a comparison of fruit produced by a plant without a soil amendment and fruit produced by a plant with a soil amendment twenty hours and thirty minutes after each had been sliced in accordance with some embodiments of the present invention.

FIG. 13 shows a photograph of a non-limiting example of a comparison of fruit produced by a plant without a soil amendment and fruit produced by a plant with a soil amendment about forty four hours after each had been sliced in accordance with some embodiments of the present invention.

FIG. 14 shows a photograph of a non-limiting example of a comparison of fruit produced by a plant without a soil amendment and fruit produced by a plant with a soil amendment about sixty nine hours and thirty minutes after each had been sliced in accordance with some embodiments of the present invention.

FIG. 15 shows a photograph of a non-limiting example of a comparison of fruit produced by a plant without a soil amendment and fruit produced by a plant with a soil amendment about ninety three hours after each had been sliced in accordance with some embodiments of the present invention.

FIG. 16 shows a photograph of a non-limiting example of a comparison of fruit produced by a plant without a soil amendment and fruit produced by a plant with a soil amendment about one hundred and eighteen hours after each had been sliced in accordance with some embodiments of the present invention.

FIG. 17 shows a photograph of a non-limiting example of a comparison of fruit produced by a plant without a soil amendment and fruit produced by a plant with a soil amendment about one hundred and forty hours after each had been sliced in accordance with some embodiments of the present invention.

FIG. 18 shows a photograph of a non-limiting example of a comparison of fruit produced by a plant without a soil amendment and fruit produced by a plant with a soil amendment about one hundred and sixty two hours and thirty minutes after each had been sliced in accordance with some embodiments of the present invention.

FIG. 19 shows a non-limiting example of soil without a soil amendment in accordance with some embodiments of the present invention.

FIG. 20 shows a non-limiting example of soil with a soil amendment in accordance with some embodiments of the present invention.

FIG. 21 shows a representative drawing of a treated plant in accordance with some embodiments of the present invention.

### DETAILED DESCRIPTION OF THE PREFERRED EMBODIMENTS

It should be understood that the present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

Embodiments of the present invention may provide a method for enhancing plants comprising the steps of providing at least some organic carbon in a soil near a plant; and perhaps even enhancing growth of said plant or may even provide a system for growing plants comprising a soil amendment having at least some organic carbon.

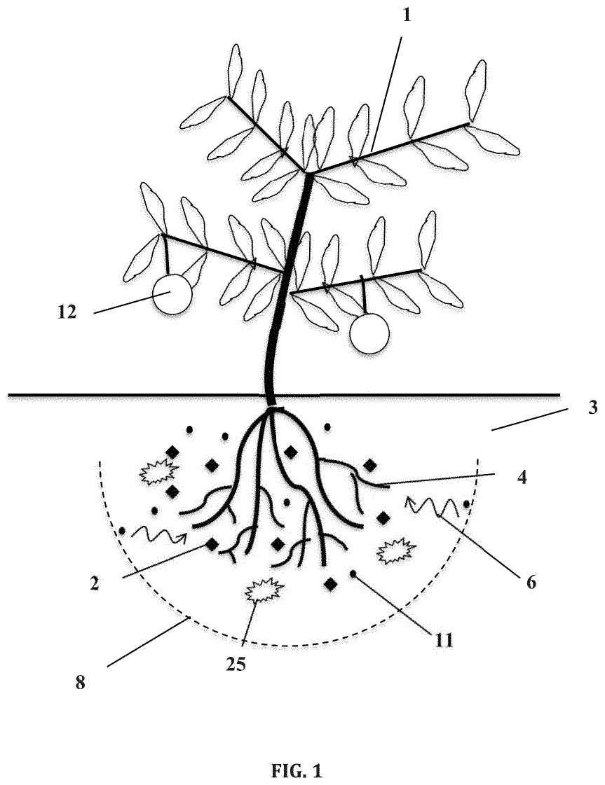

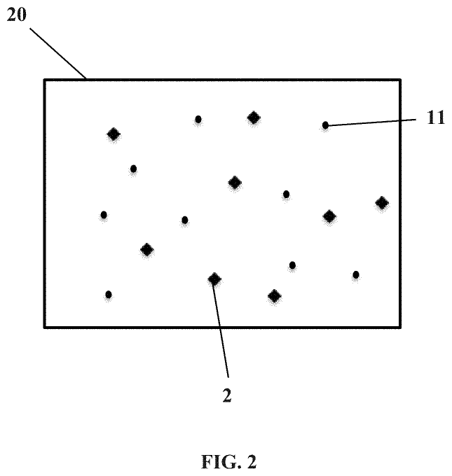

As may be understood in FIG. 1, a system may provide, in some embodiments, enhancement of plants perhaps by supplying at least some organic carbon (2) in a soil (3) near roots (4) of a plant (1). In some embodiments, the present invention may provide a soil amendment (20) that may include organic carbon (2) and perhaps other components (11) that may help in enhancing plant growth as may be understood from FIG. 2. This may provide an organic fertilizer or soil amendment which may even be mineral based. A plant (1) may be a seed, seedlings, a rudimentary plant, a grown plant, or the like.

Organic carbon by itself or perhaps as part of a soil amendment may be placed near or even in contact with roots or a root area of a plant. The organic carbon and its affiliated elements, such as but not limited to solid or liquid components, may be near roots or a root area of a plant. Near may include but is not limited to in a proximity of the roots of a plant or where roots may grow so that the organic carbon or soil amendment may be engaged by or even absorbed by the roots. Organic carbon may include but is not limited to bioavailable organic carbon, coal, low grade coal, lignite, peat, coal fines, physically processed coal, chemically processed coal, biologically processed coal, coal processing waste, coal dust, wash sludge, any combination thereof, or the like.

Embodiments of the present invention may utilize low grade coal, coal fines, biomass, certain municipal waste materials, or the like and may convert them into value-added organic fertilizer or soil amendments and even biological natural gas perhaps through a series of physiochemical and even biochemical-catalyzed reactions. Stable structures of coal may be weakened and even altered, which may result in smaller organic compounds that can be digested perhaps by pre-cultured bacterial consortia. Product solids may contain organic fractions that can be amenable to soil microorganisms perhaps as well as plant root systems, which may establish a healthy microbial ecology perhaps in a rhizosphere environment.

In some embodiments, the present invention may provide infrared or even far-infrared radiation (6) perhaps from organic carbon or its associated constituents to roots or a root area of said plant. Associated constituents may include impurities, small organic or even inorganic compounds that may be trapped, sorbed, or even chelated within coal, or the like. Where organic carbon may be incorporated into a soil amendment, it may emit infrared or even far infrared wavelengths (6) near at least some roots of a plant. A process may enable unique infrared to far-infrared emission and these wavelengths may provide a number of benefits, such as pest-repelling and control, an increase in biomass, an increase in antioxidation in fruits and plants, or the like. Emission from any source of infrared or far infrared wavelengths may be used in embodiments of the present invention. In other embodiments, any method or process which produces plants with pest-repelling, pest control, an increase in antioxidation in fruits and plants, increases biomass in a plant soil, or the like may be used.

Embodiments of the present invention may provide a mineral-based organic soil amendment perhaps with many beneficial advantages. A soil amendment (20) may include organic carbon (2) and at least one component (11). A component (11) may include but is not limited to nitrogen, phosphorus, potassium, calcium, sulfur, silicon, trace elements of iron, copper, zinc, manganese, boron, molybdenum, humic compounds, any combination thereof, or the like. Organic carbon may be bioavailable carbon. A soil amendment may contain a large amount of bioavailable organic carbon (perhaps up to about 90%).

Embodiments of the present invention may go through a rigorous material selection protocol perhaps to screen out any feedstock component that may contain hazardous metals. Organic carbon may originate from natural deposits of low-grade coal such as lignite and peat, or the like. A soil amendment may not contain any antibiotics—perhaps unlike most organic fertilizers that may be made from animal wastes.

Organic carbon or even a soil amendment containing organic carbon may enhance components (25) in a soil (3). A component (25) in a soil may include but is not limited to biomass, soil microbial populations, metabolisms of microbial populations, soil bioactivity, or the like. An amount of biomass growth, soil microbial populations and even their metabolisms, soil bioactivity, or the like may be increased perhaps as compared to a control where organic carbon or even a soil amendment is not used. In such instances a soil amendment (20) may be considered a soil microbial population enhancer, a microbial metabolism enhancer, a soil bioactivity enhancer, or the like.

In embodiments of the present invention, organic carbon or even a soil amendment may be mixed with at least one additional component (11) such as a material including but not limited to biomass, sludge, pond sludge, lake sludge, wastewater treatment plant sludge, municipal waste, any combination thereof, or the like.

Organic carbon or even a soil amendment containing organic carbon may enhance a rhizosphere health and even biomass growth. In some embodiments the present invention may provide an increase in soil permeability and even porosity, such as with a soil porosity and permeability element, in a rhizosphere (8). A rhizosphere may be an area of soil that may surround a root of a plant and may be altered by the plant's root growth, nutrients, or the like. A soil amendment may be a soil permeability element. When using organic carbon or a soil amendment, a rhizosphere soil permeability may be enhanced perhaps so that the soil may be more penetrable or even allow more diffusion, or more saturation than in soils without the organic carbon. A soil amendment may have a high amount of organic carbon perhaps at concentrations up to about 90%. Perhaps due to physiochemical and even biochemical digestions, organic carbon compounds may benefit synthesis of biomass, perhaps including cell mass and even key cellular constituents such as antioxidants, functional proteins, enzymes, or the like.

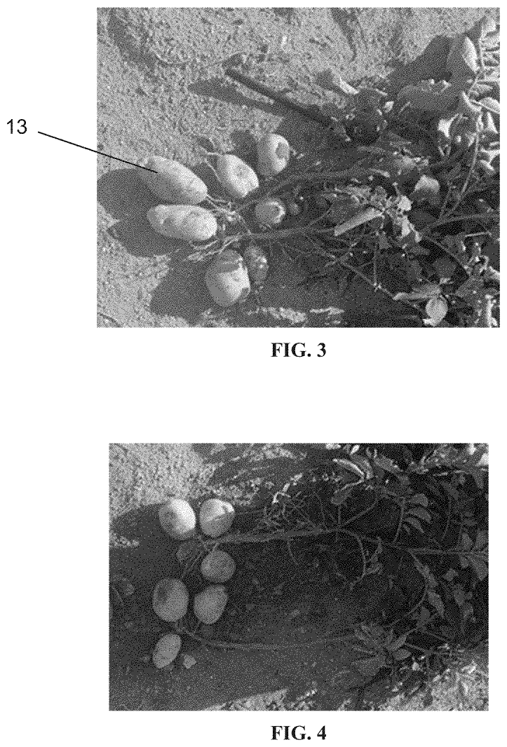

Embodiments of the present invention may provide an increase in size of a fruit (12) or vegetable (13) of a plant as compared to plant that has not been exposed to organic carbon or soil amendments as described herein. For example, in a test application in potato fields, one set of plots utilized a soil amendment with a chemical fertilizer and another set of plots, the control plots, used equal amounts of chemical fertilizer. The plot with the soil amendment yielded significantly larger potatoes (see FIG. 3) than the control plots (see FIG. 4) applied with equal amounts of chemical fertilizer. In this example, the total production of the soil amendment plots increased by approximately 40%.

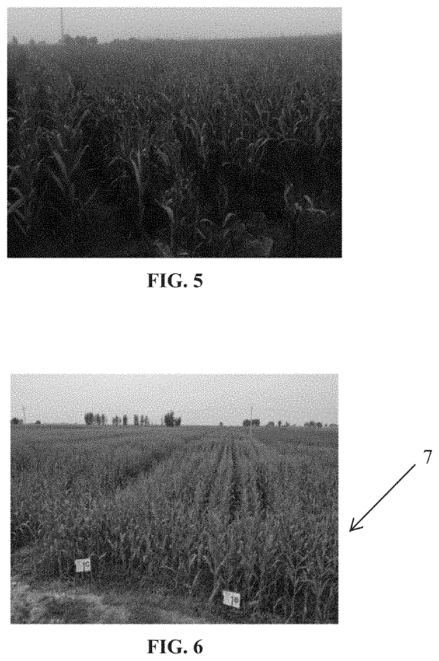

Providing organic carbon perhaps even in a soil amendment may favor a healthy ecosystem in the rhizosphere, may enhance plant resistance to pathogens and even parasites, and may even provide strengthening of a plant's immune system and repelling of pests such as parasitic insects, arachnids, plant parasitic insects, nematodes, aphids, spider mites, or the like. For example, in one fertilization test, red spider mites have been prone to infect corn plots. A control plot (see FIG. 5) used chemical fertilizer and a test plot (see FIG. 6) applied a pest repellant (7) using a soil amendment. In this example, the test plot (FIG. 6) did not have any red spider mites but the control plot did. A soil amendment may be an immune system strengthener or may even have a pest repellant capability.

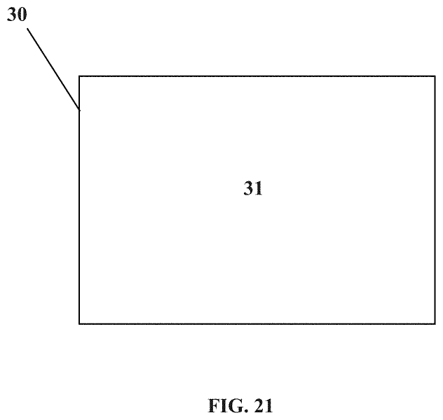

Embodiments of the present invention may provide producing substantially anti-browning fruit (5) from a plant that may be treated with organic carbon or even a soil amendment having organic carbon or the like. In embodiments, the present invention may provide increasing antioxidation in a plant; increasing antioxidation in a fruit or a vegetable of a plant; increasing a ripeness period of a fruit or a vegetable of a plant; increasing flavor of a fruit or a vegetable of a plant; increasing permeability of a soil with organic carbon; increasing fertility of a soil with organic carbon, increasing a size of a fruit or a vegetable of a plant, or the like. In embodiments, the present invention may provide a treated plant (30) that may have a characteristic (31) including but not limited to increased antioxidation, increased antioxidation in a fruit or vegetable of a plant, increased flavor of a fruit or vegetable of a plant, increased size of a fruit or vegetable, or the like as may be understood in FIG. 21.

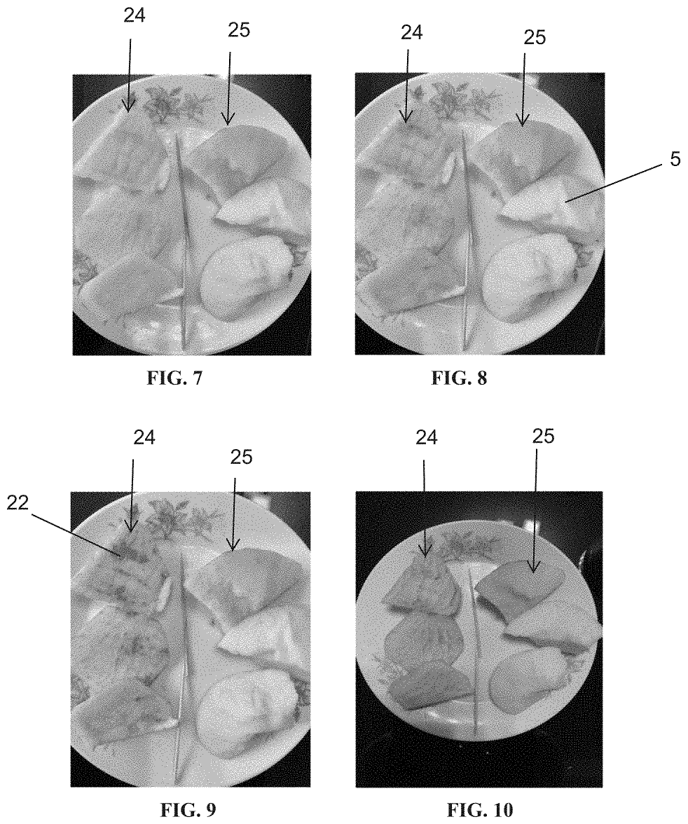

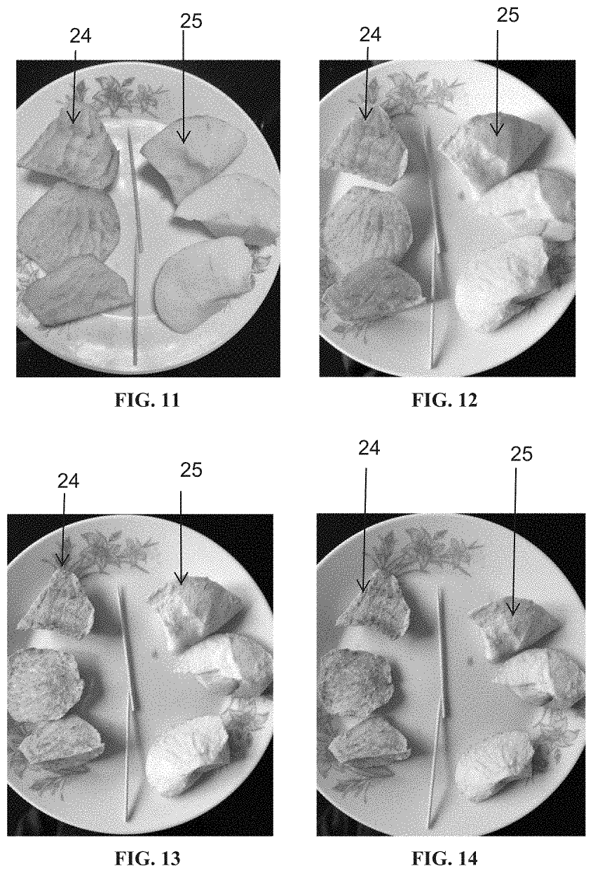

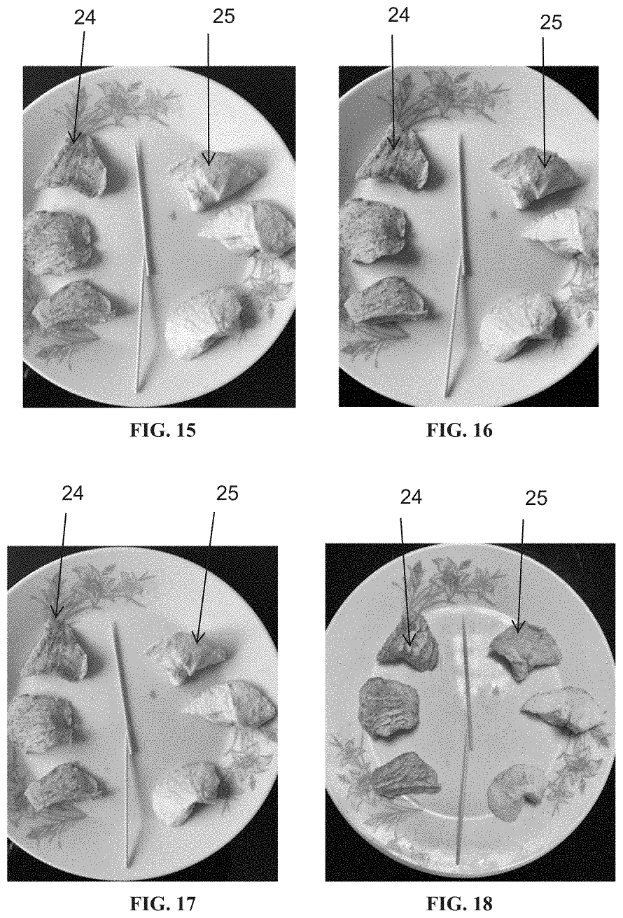

Typically fruit, such as an apple, can start to brown (22) after it has been sliced. In a test example, organic carbon via a soil amendment was applied to an apple tree. Another apple tree was not treated and fruit from both trees were tested. Photographs of the apple slices from a tree without a soil amendment are shown on the left side (24) in FIGS. 7-18 and photographs of apple slices from a tree with a soil amendment are shown on the right side (25) of FIGS. 7-18. The fruit that was treated with a soil amendment yielded apples that may be browning-resistant and even with higher antioxidation capabilities, for more than about two weeks, while the apples from the control trees brown at a quicker rate perhaps with a lower antioxidation capability. The apple trees were the same species (Fuji) and were in the same soil and an equivalent amount of standard chemical fertilizer were applied to both. For example, using percentage values as one example, for values at one end of the spectrum (e.g., substantially free of browning/anti-browning), embodiments of the present invention should be understood as encompassing the options of percentage values that include not more than 0.5%, 1%, 3%, 5%, 8% or even 10% of browning by color as compared to a non-treated fruit. In this example, the total antioxidation capability (TAOC) of the treated apples were about 8% higher than that for the untreated apple.

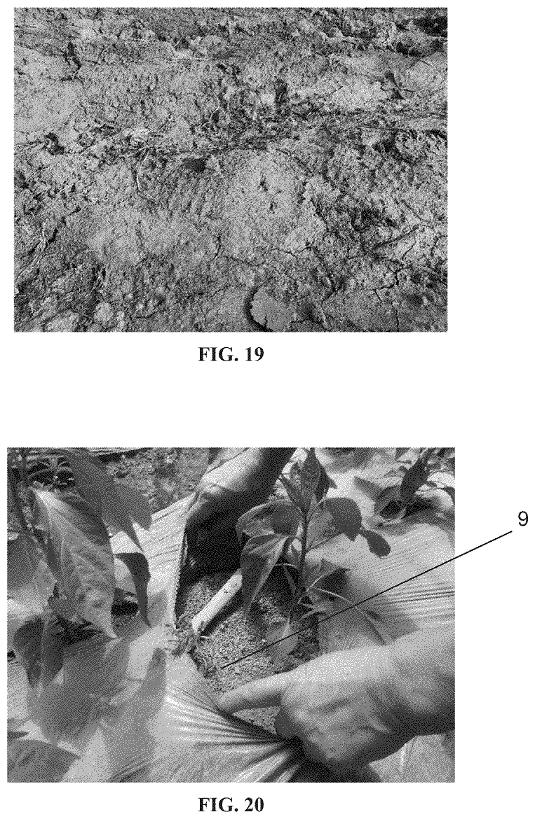

Use of organic carbon or soil amendments may provide carbon-rich and even mineral-rich soil environment. This may enhance retainment of water and even nutrients in soil. Such a healthy ecosystem may support the rigorous growth of microbes, which may further enrich organic contents in soil. Microbial metabolisms and even reproduction may result in the release of numerous small organic compounds and even microscopic carbon dioxide. These processes may help increase soil permeability and even fertility. Recent data showed a greater than about 10 times increase of soil permeability after about two months of an application with a soil amendment. In a case study in a greenhouse, plots applied with a soil amendment showed a visible “loosening” effect (9) that may benefit aeration and even migration of nutrients within the soil as can be seen in FIG. 20. In embodiments, the present invention may provide attraction of earthworms to a soil perhaps by a feature that attracts earthworms. A soil amendment (20) may provide an attraction of earthworms to a soil. In this case study, earthworms were observed migrating to the plot applied with a soil amendment. Soil in the control plot remained tight with no earthworms observed as can be understood in FIG. 19. FIG. 19 shows a control plot and FIG. 20 shows a plot one month after having been treated with a soil amendment where earthworms and their excretions were observed in the post-amended soil but not in the control soil.

The soil amendments used in the test examples as described herein included constituents of nitrogen, phosphorus, and potassium, bioavailable organic carbon (up to about 90%), calcium, sulfur, silicon, humic compounds, trace elements of iron, copper, zinc, manganese, boron, and molybdenum (and various others).

Embodiments of the present invention may provide soil amendments that may enhance yields of crops and other plants of ecological and economical values and may even improve the taste of crops and fruits which may further increase nutritional and commercial values. Perhaps by diverting coal, carbon that may have once been released into the atmosphere from coal combustion may be used to produce an organic fertilizer, soil amendment, or the like. Application of a soil amendment may retain carbon in soils, improve the soil quality and fertility, enhance biomass growth, capture more carbon (perhaps as carbon dioxide) from the atmosphere, or the like. This synergistic circle can achieve a “carbon-negative” mechanism. Foreseeing the trend of low-carbon economy, embodiments of the present invention may demonstrate social and environmental stewardship while achieving significant economical gains.

As can be easily understood from the foregoing, the basic concepts of the present invention may be embodied in a variety of ways. It involves both plant enhancement techniques as well as devices to accomplish the appropriate plant enhancer. In this application, the plant enhancement techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition; correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified. For example, using percentage values as one example, for values at one end of the spectrum (e.g., substantially free of browning/anti-browning), embodiments of the present invention should be understood as encompassing the options of percentage values that include not more than 0.5%, 1%, 3%, 5%, 8% or even 10% as browning compared to a non-treated fruit by color. In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “enhancer” should be understood to encompass disclosure of the act of “enhancing”—whether explicitly discussed or not—and, conversely, were there effectively disclosure of the act of “enhancing”, such a disclosure should be understood to encompass disclosure of a “enhancer” and even a “means for enhancing.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the information disclosure statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the soil amendment devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. A method for enhancing plants comprising the steps of:
providing at least some organic carbon in a soil near a plant; and
enhancing growth of said plant.

2. The method as described in claim 1 and further comprising a step of contacting said at least some organic carbon to at least some of roots of said plant.

3. The method as described in claim 1 and further comprising a step of contacting said at least some organic carbon and its affiliated elements to at least some roots or root area of said plant.

4. The method as described in claim 3 wherein said affiliated elements comprises solid or liquid.

5. The method as described in claim 1 and further comprising a step of producing substantially anti-browning fruit from said plant.

6. The method as described in claim 1 and further comprising a step selected from a group of increasing antioxidation in said plant; increasing antioxidation in a fruit or a vegetable of said plant; increasing a ripeness period of a fruit or a vegetable of said plant; increasing flavor of a fruit or a vegetable of said plant; increasing porosity and permeability of said soil with said organic carbon; increasing a size of a fruit or a vegetable of a plant; and increasing fertility of said soil with said organic carbon.

7. The method as described in claim 2 and further comprising a step of providing infrared or far-infrared radiation from said at least some organic carbon or its associated constituents to said at least some roots or root area of said plant.

8. The method as described in claim 1 and further comprising a step of strengthening said plant's immune system and repelling pests from said plant.

9. The method as described in claim 8 wherein said pests are selected from a group consisting of parasitic insects, arachnids, nematodes, aphids, and spider mites.

10. The method as described in claim 1 and further comprising a step of enhancing a rhizosphere soil porosity and permeability.

11. The method as described in claim 1 and further comprising a step of attracting earthworms to said soil.

12. The method as described in claim 1 wherein said organic carbon is selected from a group consisting of bioavailable organic carbon, coal, low grade coal, lignite, peat, coal fines, physically processed coal, chemically processed coal, biologically processed coal, coal processing waste, coal dust, wash sludge, and any combination thereof.

13. The method as described in claim 12 and further comprising mixing said organic carbon with a material selected from a group consisting of biomass, sludge, pond sludge, lake sludge, wastewater treatment plant sludge, municipal waste, and any combination thereof.

14. The method as described in claim 1 wherein said plant is selected from a group consisting of a seed, seedlings, a rudimentary plant, and a grown plant.

15. The method as described in claim 1 and further comprising a step of increasing an amount of biomass in said soil with said organic carbon.

16. The method as described in claim 1 and further comprising a step of increasing soil permeability of said soil with said organic carbon.

17. The method as described in claim 1 and further comprising a step of providing a soil amendment containing said organic carbon; and wherein said soil amendment further comprises a component selected from a group consisting of nitrogen, phosphorus, potassium, calcium, sulfur, silicon, trace elements of iron, copper, zinc, manganese, boron, molybdenum, humic compounds, and any combination thereof.

18. The method as described in claim 1 and further comprising a step of enhancing soil microbial populations and their metabolisms with said at least some organic carbon.

19. The method as described in claim 1 and further comprising a step of enhancing soil bioactivity with said at least some organic carbon.

20. A system for growing plants comprising a soil amendment having at least some organic carbon.

21-35. (canceled)
